(19) United States
(12) Patent Application Publication
(10) Pub. No.: US 2004/0191636 A1
(43) Pub. Date: Sep. 30, 2004

(54) Nonaqueous electrolyte secondary battery

(76) Inventors: Yoshinori Kida, Kobe-city (JP); Katsunori Yanagida, Itami-city (JP); Atsushi Yanai, Kobe-city (JP); Takaaki Ikemachi, Kobe-city (JP); Toshiyuki Nohma, Kobe-city (JP)

Correspondence Address: KUBOVCIK & KUBOVCIK, SUITE 710, 900 17TH STREET NW, WASHINGTON, DC, 20006

(21) Appl. No.: 10/809,842

(22) Filed: Mar. 26, 2004

(30) Foreign Application Priority Data
Mar. 28, 2003 (JP) 2003-090505

(51) Int. Cl. H01M 10/40; H01M 4/58

(52) U.S. Cl. 429/330; 429/340; 429/329; 429/231.8

(57) ABSTRACT

A nonaqueous electrolyte secondary battery including a positive electrode containing a positive electrode active material, a negative electrode containing a carbon material as a negative electrode active material, and a nonaqueous electrolyte containing a solvent and a solute wherein sulfolane is included in the nonaqueous electrolyte as a solvent and vinyl ethylene carbonate and vinylene carbonate or a derivative of the vinylene carbonate are added to the nonaqueous electrolyte.

### FIELD OF THE INVENTION

The present invention relates to a nonaqueous electrolyte secondary battery. More particularly, the present invention relates to a nonaqueous electrolyte secondary battery including a nonaqueous electrolyte containing sulfolane as a solvent.

### BACKGROUND OF THE INVENTION

A lithium secondary battery having a high energy density has recently been in high demand as the market for cellular phones, notebook type PCs, portable information terminals, and the like, has expanded.

As an electrolyte for a nonaqueous electrolyte secondary battery, there is commonly used a solution of a lithium salt such as LiBF₄, LiPF₆ and LiClO₄ in an aprotic solvent. As the aprotic solvent, carbonates, for example, propylene carbonate, ethylene carbonate, diethyl carbonate, ethyl methyl carbonate, and the like; esters, for example, γ-butyrolactone, methyl acetate, and the like; ethers, for example, diethoxy ethane, and the like, are used. Among these solvents a cyclic carbonate is particularly useful as a solvent for a nonaqueous electrolyte battery due to a large dielectric constant and electrochemical stability in a range of 0.0 V˜4.5 V (vs. Li/Li⁺). On the other hand, it is expected that sulfolane may contribute to improve the safety of a nonaqueous electrolyte battery if it is used as the solvent because it has a higher boiling point of 287° C. than propylene carbonate or ethylene carbonate.

However, a freezing point of sulfolane is high, i.e., 28° C., and when sulfolane is used as the main solvent of a nonaqueous electrolyte, characteristics of the battery at a low temperature are deteriorated. Compatibility of sulfolane with a graphite negative electrode is poor. It is known that a graphite negative electrode cannot be charged to C₆Li, which is a theoretical discharge capacity of graphite, in a nonaqueous electrolyte including sulfolane, even if ethylene carbonate is mixed with sulfolane.

A mixture of sulfolane and ethyl methyl carbonate as a solvent for a nonaqueous electrolyte has been proposed in Japanese Patent Laid-open Publication No. 2000-12078. However, when a solvent having a low boiling point such as ethyl methyl carbonate is mixed with sulfolane, the advantage of sulfolane of contributing to the safety of a battery based on the fact that sulfolane is a high boiling point solvent, is significantly lost.

Addition of vinylene carbonate to a solvent having a high dielectric constant has been proposed in Japanese Patent Laid-open Publication No. 2001-297794. However, if vinylene carbonate is merely added to sulfolane sufficient initial charge and discharge characteristics cannot be obtained.

As explained above, a battery using sulfolane as a solvent for a nonaqueous electrolyte does not obtain sufficient charge and discharge characteristics in spite of the expectation that sulfolane can improve safety of a battery due to its high boiling point.

### OBJECT OF THE INVENTION

An object of the present invention is to improve the charge and discharge characteristics of a nonaqueous electrolyte secondary battery comprising sulfolane as a solvent of the nonaqueous electrolyte.

### SUMMARY OF THE INVENTION

The nonaqueous electrolyte secondary battery of the present invention comprises a positive electrode containing a positive electrode active material, a negative electrode containing a carbon material as a negative electrode active material, and a nonaqueous electrolyte comprising a solvent and a solute wherein sulfolane is included in the nonaqueous electrolyte as a solvent and vinyl ethylene carbonate and vinylene carbonate or derivatives thereof are added to the nonaqueous electrolyte.

### BRIEF DESCRIPTION OF THE DRAWINGS

FIG. 1 is a cross section of a battery prepared in the Examples and Comparative Examples.

[Explanation of Elements]

1: working electrode

2: counter electrode

3: separator

4: battery can on working electrode side

5: battery can on counter electrode side

6 and 7: current collector

8: insulation packing

### DETAILED EXPLANATION OF THE INVENTION

According to the present invention, when vinyl ethylene carbonate and vinylene carbonate or a derivative thereof are added to a nonaqueous electrolyte of a nonaqueous electrolyte secondary battery, charge and discharge characteristics can be improved. The reason for this is believed to be that a film which is stable and excellent in the mobility of lithium ions is formed on a surface of a carbon negative electrode when vinyl ethylene carbonate and vinylene carbonate or a derivative thereof are added to the nonaqueous electrolyte. Such film is formed on the surface of the negative electrode when vinyl ethylene carbonate and vinylene carbonate and/or derivatives thereof are reduced during the initial charge.

The amount of sulfolane contained in the nonaqueous electrolyte is preferably at least 15% by volume, on the basis of the total amount of the solvent, and more preferably, is in a range of 20˜45 volume %. If the amount of sulfolane is not sufficient, the effect of improved safety of the battery may not be sufficiently obtained. If the amount of sulfolane is too much, the freezing point of the electrolyte may be too high for practical use.

The amount of vinyl ethylene carbonate added to the nonaqueous electrolyte is preferably in a range of 0.1˜5 parts by weight per 100 parts by weight of the nonaqueous electrolyte, and more preferably, in a range of 1˜3 parts by weight.

The amount of vinylene carbonate or a derivative thereof added to the nonaqueous electrolyte is preferably in a range of 0.1˜5 parts by weight per 100 parts by weight of the nonaqueous electrolyte, and more preferably, in a range of 1˜3 parts by weight.

If vinyl ethylene carbonate and vinylene carbonate or a derivative thereof are not added in a sufficient amount, the effect of improvement of charge discharge characteristics may not be obtained. However, if they are added in too great an amount, the film formed on the negative electrode is too thick and reaction resistance of the negative electrode increases to deteriorate charge discharge characteristics.

As the vinylene carbonate derivative, 4,5-dimethyl vinylene carbonate, 4,5-diethyl vinylene carbonate, 4,5-dipropyl vinylene carbonate, 4-ethyl-5-methyl vinylene carbonate, 4-ethyl-5-propyl vinylene carbonate, 4-methyl-5-propyl vinylene carbonate, and the like, can be illustrated. Among vinylene carbonate and the derivatives thereof, vinylene carbonate is especially preferred because it has excellent charge discharge cycle performance. Vinylene carbonate and the derivatives thereof can be used alone or in combinations thereof.

As a solvent to be mixed with sulfolane, cyclic esters, for example, ethylene carbonate, propylene carbonate, 1,2-butylene carbonate, 2,3-butylene carbonate, and the like; γ-butyrolactone, propane sultone, and the like, can be illustrated. Other conventional nonaqueous solvents for a nonaqueous electrolyte battery, for example, methyl acetate, ethyl acetate, propyl acetate, methyl propionate, ethyl propionate, tetrahydrofuran, 2-methyl tetrahydrofuran, 1,4-dioxane, 1,2-dimethoxyethane, 1,2-diethoxyethane, acetonitrile, and the like, can also be used. γ-Butyrolactone and propylene carbonate are preferred because they can compensate for a defect of sulfolane which has the high freezing point. γ-Butyrolactone is more preferred because a mechanism to form a film on the surface of the carbon negative electrode is similar to that of sulfolane.

It is preferred to add surfactant, for example, trioctyl phosphate or esters having a large molecular weight to the nonaqueous electrolyte to improve wettability to a separator. The amount of the surfactant is in a range of 0.5˜5 parts by weight per 100 parts of the nonaqueous electrolyte.

As the solute, LiPF₆, LiAsF₆, LiBF₄, LiCF₃SO₃, LiN(CₗF₂ₗ₊₁SO₂) (CₘF₂ₘ₊₁SO₂) (wherein 1 and m are each an integer of 1 or more), LiC (CₚF₂ₚ₊₁SO₂) (C_{q}F_{2q+1}SO₂) (CᵣF₂ᵣ₊₁SO₂) (wherein p, q and r are each an integer of 1 or more), and the like, can be illustrated. The solutes can be used alone or in various combinations thereof. The concentration of the solute is preferably in a range of 0.1˜1.5 mol/l and, more preferably, in a range of 0.5˜1.5 mol/l.

There are no limitations with respect to an active material for the negative electrode if the material is a carbon material. However, from the standpoint of forming a good quality of film on the surface of the negative electrode in the electrolyte containing sulfolane, an R value (I_{D}/I_{G}) is at least 0.2 is preferred. The ratio of the Raman spectrum intensity (R) (I_{D}/I_{G}) is a ratio of a peak intensity at 1360 cm⁻¹ (I_{D}) to a peak intensity at 1580 cm⁻¹ (I_{G}) as measured using argon ion laser Raman spectroscopy. A peak at 1580 cm⁻¹ is derived from a crystalline portion having hexagonal symmetry which has a structure close to a graphite structure. A peak at 1360 cm⁻¹ is derived from an amorphous portion where crystallinity of the carbon material falls into disorder. When the ratio of the amorphous portion in a surface layer is higher, R is greater. If the carbon material has low crystallinity on the surface, a fine uniform film can be formed. Therefore, if the carbon material has an R value (I_{D}/I_{G}) of 0.2 or higher, excellent discharge characteristics can be obtained. On the other hand if the carbon material has an R value (I_{D}/I_{G}) of greater than 1.0, the surface is very amorphous and it may cause deterioration of charge and discharge efficiency. Therefore, the R value (I_{D}/I_{G}) is preferably in a range of 0.2˜1.0, and more preferably 0.3˜0.6.

As the carbon material, a composite carbon material comprising a first carbon material as a core and a second carbon material which coats partially or entirely a surface of the first carbon material can be used. A second carbon material having a smaller crystallinity than the first carbon material is used. This makes it possible to control crystallinity of the surface of the carbon material and to provide a nonaqueous electrode secondary battery having excellent discharge characteristics.

Regarding how to coat the first carbon material with the second carbon material, carbonizing the first carbon material mixed with an organic compound which can be carbonized, introducing an organic compound vapor onto the carbon material forming the core (CVD), and the like, can be illustrated.

As the organic compound to be mixed with the carbon material for the baking method, pitch, tar, phenol-formaldehyde resin, fulfuryl alcohol resin, carbon black, vinylidene chloride, cellulose, and the like, can be illustrated. These organic compounds can be dissolved in an organic solvent such as methanol, ethanol, benzene, acetone, toluene, and the like, when they are used. The core carbon material is immersed in the organic solution of the organic compound, and is carbonized at 500° C.˜1,800° C., preferably 700° C.˜1,400° C., in an inert gas atmosphere.

As the organic compound to be used for CVD, a hydrocarbon, for example, methane, ethane, propane, butane, ethylene, propylene, butene, benzene, toluene, ethylbenzene, cyclohexane, cyclopentene, and the like, and derivatives thereof, can be illustrated. The composite carbon material can be prepared by heating the organic compound to cause it to vaporize and introducing the vapor into a reaction chamber containing the carbon material as a core material with nitrogen or an inert gas as a carrier. The carbon material is treated at 500° C.˜1,800° C., preferably 700° C.˜1,400° C.

Graphite is preferred among the carbon material to be used as the active material for the negative electrode. Especially, a carbon material having a spacing of crystalline (002) planes (d₀₀₂) observed by X-ray diffraction analysis in a range of 0.335˜0.338 nm, and a crystalline size in the direction of the c axis (Lc) of not less than 30 nm is preferred. A carbon material having a d₀₀₂ value in a range of 0.335˜0.336 nm and an Lc of 100 nm or greater is more preferable. When a carbon material meeting such specifications is used, the battery can obtain a high discharge capacity.

A carbon material having a ratio (I₁₁₀/I₀₀₂) of peak intensity of crystalline (110) planes (I₁₁₀) to peak intensity of crystalline (002) planes (I₀₀₂) in a range of 5×10⁻³˜1.5×10⁻² is preferred. If the carbon material has this ratio, high rate discharge characteristics can be improved.

The carbon material described above is mixed by a conventional method with a binder, for example, polytetrafluoroethylene (PTFE), polyvinylidene fluoride (PVdF), styrene-butadiene rubber, and the like, to prepare a negative electrode mixture.

There are no limitations with respect to an active material for the positive electrode. Materials conventionally used as an active material for a positive electrode in a lithium secondary battery can be used. For example, a transition metal oxide including lithium such as lithium cobalt oxide (LiCoO₂), lithium nickel oxide (LiNiO₂), lithium manganese oxide (LiMn₂O₄), and the like, can be used. These materials can be used as a positive electrode mixture material by mixing with a conductive agent, for example, acetylene black, carbon black, and the like, and a binder, for example, polytetrafluoroethylene (PTFE), polyvinylidene fluoride (PVdF), and the like.

The nonaqueous electrolyte secondary battery of the present invention comprises other battery components, for example, a separator, a battery case, a current collector which holds the active materials and collects current, in addition to the positive electrode active material, the negative electrode active material, and the nonaqueous electrolyte described above. There are no limitations with respect to the other battery components and various component including conventional components can be used.

The first charge after pouring the electrolyte during the steps of manufacturing the battery is preferably performed at a current of not greater than the 5 hour rate (0.2 C). If the charge current of the initial charge is greater than the 5 hour rate, the film formed by vinyl ethylene carbonate and vinylene carbonate or derivatives thereof is not formed evenly and excellent discharge characteristics may not be obtained. Charging to a capacity of 10% or greater at a current of not greater than the 5 hour rate at the beginning of the first charge is preferred and then charging can be performed at a current of greater than the 5 hour rate.

### DESCRIPTION OF PREFERRED EMBODIMENT

Embodiments of the present invention are explained in detail below. It is of course understood that the present invention is not limited to these embodiments and can be modified within the spirit and scope of the appended claims.

### (Example 1)

### [Preparation of Working Electrode}

A graphite powder (d₀₀₂=0.336 nm, Lc>100 nm) was immersed in melted pitch, was separated and was dried to obtain graphite coated with pitch. The graphite coated with pitch was carbonized at 1,100° C. for two hours to prepare graphite coated with low crystalline carbon thereon as a carbon material. An intensity ratio (R) (I_{D}/I_{G}) obtained by Raman spectroscopy of the carbon material was 0.40. A ratio (I₁₁₀/I₀₀₂) of a peak intensity of crystalline (110) planes (I₁₁₀) to a peak intensity of crystalline (002) planes (I₀₀₂) by X-ray diffraction analysis of the carbon material was 1.1×10⁻².

97.5 parts by weight of the carbon material, 1 part by weight of a styrene-butadiene rubber, and 1.5 parts by weight of carboxymethylcellulose were mixed and water was added to the mixture to prepare a slurry. The slurry was coated on one side of a current collector made of copper, was compressed after drying, and was cut into a disc having a diameter of 20 mm to prepare a working electrode.

### [Preparation of Counter Electrode]

A lithium rolled plate having a desired thickness and cut into a disk having a diameter of 20 mm was used as a counter electrode.

### [Preparation of Electrolyte]

Lithium tetrafluoroborate (LiBF₄) was dissolved in a mixed solvent of sulfolane (SL) and γ-butyrolactone (γBL) in a ratio of 30:70 by volume to provide a LiBF₄ concentration of 1.2 mol/l to prepare a nonaqueous electrolyte. 2 Parts by weight of vinyl ethylene carbonate (VEC), 2 parts by weight of vinylene carbonate (VC) and 2 parts by weight of trioctyl phosphate (TOP) as a surfactant were added to the nonaqueous electrolyte (100 parts by weight).

### [Assembly of Evaluation Battery]

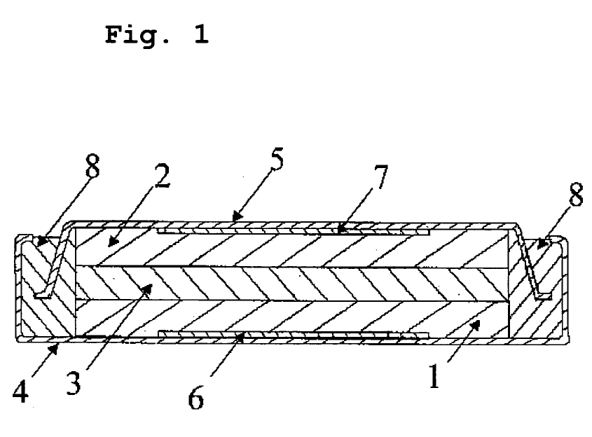

The above-prepared working electrode, counter electrode and electrolyte were used to assemble a flat shaped battery A1 for evaluation (battery size: a diameter of 24.0 mm and a thickness of 3.0 mm) as shown in FIG. 1. A separator 3 was inserted between the working electrode 1 and the counter electrode 2. The electrodes and separator were placed in a battery case comprising a battery can 4 on the working electrode side and a battery can 5 on the counter electrode side. The counter electrode contacted the battery can 5 through a current collector plate 7 (on the counter electrode side). The working electrode 1 was connected to the battery can 4 through a current collector plate 6 (on the working electrode side). The outer edge of the battery can 5 was inserted in the battery can 4 and they were electrically insulated by an insulation packing 8. As the separator 3, a polyethylene porous film impregnated with the nonaqueous electrolyte was used.

The above-described battery was prepared to evaluate charge discharge characteristics of the negative electrode and the electrolyte. When a current is input on the working electrode in a direction to discharge electrochemically, the working electrode as the negative electrode occludes lithium ions and the negative electrode is charged. When a current is input on the working electrode in a direction to charge electrochemically, the working electrode as the negative electrode releases lithium ions and the negative electrode is discharged. The battery was designed to have ultra excessive lithium metal from the standpoint of electronic capacity and it is possible to evaluate characteristics of the negative electrode and the electrolyte by the battery.

Using the battery A1, the negative electrode was charged (electrochemically discharged) at a current density of 0.5 mA/cm² (an end voltage of 0.0 V), of 0.25 mA/cm² (an end voltage of 0.0 V), and 0.1 mA/cm² (an end voltage of 0.0 V); and was discharged (electrochemically charged) at a current density of 0.25 mA/cm² (an end voltage of 1.0 V) to evaluate charge discharge characteristics of the negative electrode. An initial charge capacity, initial discharge capacity and initial charge discharge efficiency are shown in Table 1.

### (Example 2 and Comparative Examples 1˜3)

A battery for evaluation A2 and batteries for comparison X1˜X3 were prepared in the same manner as Example 1 except that the amounts of VEC and VC were varied as shown in Table 1. The batteries A2 and X1˜X3 were evaluated regarding initial charge and discharge characteristics in the same manner as Example 1. The results are shown in Table 1.

TABLE 1

| | | | | | Initial |
|---|---|---|---|---|---|
| | VEC | VC | Initial | Initial | Charge |
| | (parts | (parts | Charge | Discharge | Discharge |
| | by | by | Capacity | Capacity | Efficiency |
| Battery | weight) | weight) | (mAh/g) | (mAh/g) | (%) |
| A1 | 2 | 2 | 385 | 361 | 93.8 |
| A2 | 4 | 2 | 337 | 317 | 94.0 |
| X1 | 0 | 0 | 357 | 297 | 83.2 |
| X2 | 4 | 0 | 266 | 227 | 85.3 |
| X3 | 0 | 2 | 336 | 299 | 89.0 |

As is clear from the results shown in Table 1, batteries A1 and A2 according to the present invention in which vinyl ethylene carbonate (VEC) and vinylene carbonate (VC) were added to the electrolyte have greater discharge capacities and high initial charge discharge efficiencies as compared to batteries X1˜X3. It is believed that these results are obtained because a good quality film having high mobility of lithium ions was formed on the surface of the graphite negative electrode by using vinyl ethylene carbonate (VEC) and vinylene carbonate (VC) together to improve charge discharge characteristics.

Although the batteries described above were used for evaluation in the Examples, the present invention can be widely applied to a nonaqueous electrolyte secondary battery. For example, in a battery wherein LiCoO₂, LiNiO₂, LiMn₂O₄, or the like, is used for a positive electrode active material, similar results are obtained. There are no limitations with respect to the shape of the battery and various shapes, for example, cyclindical, prismatic, flat, and the like, can be illustrated.

### ADVANTAGES OF THE INVENTION

According to the present invention, charge discharge characteristics of a nonaqueous electrolyte secondary battery comprising sulfolane as a solvent for a nonaqueous electrolyte are improved.

What is claimed is:

1. A nonaqueous electrolyte secondary battery comprising a positive electrode including a positive electrode active material, a negative electrode including a carbon material as a negative electrode active material and a nonaqueous electrolyte including a solvent and a solute, wherein sulfolane is contained as a solvent in the nonaqueous electrolyte and vinyl ethylene carbonate and vinylene carbonate or a derivative of vinylene carbonate are added to the nonaqueous electrolyte.

2. The nonaqueous electrolyte secondary battery according to claim 1, wherein sulfolane is contained in an amount of at least 15% by volume, on the basis of the total volume of the solvent.

3. The nonaqueous electrolyte secondary battery according to claim 1, wherein the amount of vinyl ethylene carbonate added to the nonaqueous electrolyte is in a range of 0.1˜5 parts by weight per 100 parts by weight of the nonaqueous electrolyte.

4. The nonaqueous electrolyte secondary battery according to claim 2, wherein the amount of vinyl ethylene carbonate added to the nonaqueous electrolyte is in a range of 0.1˜5 parts by weight per 100 parts by weight of the nonaqueous electrolyte.

5. The nonaqueous electrolyte secondary battery according to claim 1, wherein the amount of vinylene carbonate or a derivative thereof added to the nonaqueous electrolyte is in a range of 0.1˜5 parts by weight per 100 parts by weight of the nonaqueous electrolyte.

6. The nonaqueous electrolyte secondary battery according to claim 2, wherein the amount of vinylene carbonate or a derivative thereof added to the nonaqueous electrolyte is in a range of 0.1˜5 parts by weight per 100 parts by weight of the nonaqueous electrolyte.

7. The nonaqueous electrolyte secondary battery according to claim 3, wherein the amount of vinylene carbonate or a derivative thereof added to the nonaqueous electrolyte is in a range of 0.1˜5 parts by weight per 100 parts by weight of the nonaqueous electrolyte.

8. The nonaqueous electrolyte secondary battery according to claim 4, wherein the amount of vinylene carbonate or a derivative thereof added to the nonaqueous electrolyte is in a range of 0.1˜5 parts by weight per 100 parts by weight of the nonaqueous electrolyte.

9. The nonaqueous electrolyte secondary battery according to claim 1, wherein the nonaqueous electrolyte contains γ-butyrolactone and sulfolane as the main solvents.

10. The nonaqueous electrolyte secondary battery according to claim 2, wherein the nonaqueous electrolyte contains γ-butyrolactone and sulfolane as the main solvents.

11. The nonaqueous electrolyte secondary battery according to claim 3, wherein the nonaqueous electrolyte contains γ-butyrolactone and sulfolane as the main solvents.

12. The nonaqueous electrolyte secondary battery according to claim 4, wherein the nonaqueous electrolyte contains γ-butyrolactone and sulfolane as the main solvents.

13. The nonaqueous electrolyte secondary battery according to claim 5, wherein the nonaqueous electrolyte contains γ-butyrolactone and sulfolane as the main solvents.

14. The nonaqueous electrolyte secondary battery according to claim 6, wherein the nonaqueous electrolyte contains γ-butyrolactone and sulfolane as the main solvents.

15. The nonaqueous electrolyte secondary battery according to claim 7, wherein the nonaqueous electrolyte contains γ-butyrolactone and sulfolane as the main solvents.

16. The nonaqueous electrolyte secondary battery according to claim 8, wherein the nonaqueous electrolyte contains γ-butyrolactone and sulfolane as the main solvents.

17. The nonaqueous electrolyte secondary battery according to claim 1, wherein the carbon material has a ratio ( I_{D}/I_{G}) of a Raman spectrum intensity (R) obtained by Raman spectroscopy of 0.2 or greater.

18. The nonaqueous electrolyte secondary battery according to claim 2, wherein the carbon material has a ratio (I_{D}/I_{G}) of a Raman spectrum intensity (R) obtained by Raman spectroscopy of 0.2 or greater.

19. The nonaqueous electrolyte secondary battery according to claim 3, wherein the carbon material has a ratio (I_{D}/I_{G}) of a Raman spectrum intensity (R) obtained by Raman spectroscopy of 0.2 or greater.

20. The nonaqueous electrolyte secondary battery according to claim 5, wherein the carbon material has a ratio (I_{D}/I_{G}) of a Raman spectrum intensity (R) obtained by Raman spectroscopy of 0.2 or greater.
